(19) United States
(12) Patent Application Publication
(10) Pub. No.: US 2026/0142252 A1
(43) Pub. Date: May 21, 2026

(54) ALL-SOLID-STATE BATTERY SYSTEM

(71) Applicant: TOYOTA JIDOSHA KABUSHIKI KAISHA, Toyota-shi (JP)

(72) Inventors: Shota IMAI, Nisshin-shi (JP); Tsubasa MIGITA, Osaka (JP); Keiichi MINAMIURA, Nagoya-shi (JP)

(73) Assignee: TOYOTA JIDOSHA KABUSHIKI KAISHA, Toyota-shi (JP)

(21) Appl. No.: 19/294,744

(22) Filed: Aug. 8, 2025

(30) Foreign Application Priority Data
Nov. 19, 2024 (JP) 2024-201336

(51) Int. Cl. H01M 10/42; H01M 10/0525; H01M 10/0562; H01M 10/44; H01M 10/48

(52) U.S. Cl. CPC H01M 10/425; H01M 10/0525; H01M 10/0562; H01M 10/443; H01M 10/486; H01M 2010/4271

(57) ABSTRACT

A vehicle (all-solid-state battery system) includes a battery that is an all-solid-state lithium-ion battery, a voltage sensor, a current sensor, a temperature sensor, a PCU configured to charge and discharge the battery, and an ECU that controls the PCU. The ECU calculates an internal resistance of the battery based on first information including a temperature and an SOC of the battery, calculates a diffusion resistance of the battery based on second information including a discharge current summation value of the battery, corrects the internal resistance by adding the diffusion resistance to the internal resistance, estimates the voltage of the battery at a specified amount of time after present, based on the internal resistance that is corrected, a present voltage of the battery, and a present current of the battery, and controls the PCU such that the voltage that is estimated does not fall below an operating lower limit voltage.

### CROSS-REFERENCE TO RELATED APPLICATION

This application claims priority to Japanese Patent Application No. 2024-201336 filed on Nov. 19, 2024. The disclosure of the above-identified application, including the specification, drawings, and claims, is incorporated by reference herein in its entirety.

### BACKGROUND

### 1. Technical Field

The present disclosure relates to an all-solid-state battery system.

### 2. Description of Related Art

A battery system that is disclosed in Japanese Unexamined Patent Application Publication No. 2018-10722 (JP 2018-10722 A) is configured to estimate an amount of time during which a nickel metal hydride battery can continuously output a predetermined electric power before voltage thereof reaches a lower limit voltage.

### SUMMARY

In order to protect a battery, it is conceivable to estimate voltage of the battery over a specified amount of time from the present, and suppress discharge of the battery (perform output limitation) such that the voltage that is estimated does not fall below a lower limit voltage that is set in advance. This control is referred to as “lower limit voltage protection control”.

The present inventors have found that in a case of a battery that is an all-solid-state lithium-ion battery, the voltage of the battery readily falls below the lower limit voltage, due to characteristics of the all-solid-state lithium-ion battery. As such, there is a possibility that the battery cannot not be appropriately protected even when the lower limit voltage protection control is executed.

The present disclosure has been made to solve the above problem, and one of the objects of the present disclosure is to appropriately protect a battery that is an all-solid-state lithium-ion battery.

An all-solid-state battery system according to an aspect of the present disclosure includes a battery that is an all-solid-state lithium-ion battery, a voltage sensor for detecting a voltage of the battery, a current sensor for detecting a current of the battery, a temperature sensor for detecting a temperature of the battery, a power conversion device that is configured to charge and discharge the battery, and a control device for controlling the power conversion device. The control device (1) calculates an internal resistance of the battery based on first information including the temperature and a state of charge (SOC) of the battery, (2) calculates a diffusion resistance of the battery based on second information including a discharge current summation value of the battery, (3) corrects the internal resistance by adding the diffusion resistance to the internal resistance, (4) estimates the voltage of the battery at a specified amount of time after present, based on the internal resistance that is corrected, a present voltage of the battery, and a present current of the battery, and (5) controls the power conversion device such that the voltage that is estimated does not fall below a lower limit voltage.

According to the present disclosure, a battery that is an all-solid-state lithium-ion battery can be appropriately protected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a hardware configuration of a vehicle according to an embodiment;

FIG. 2 is a diagram showing a relation between voltage and current of a battery;

FIG. 3 is a diagram for schematically describing lower limit voltage protection control;

FIG. 4 is a conceptual diagram for describing diffusion resistance of the battery;

FIG. 5 is a functional block diagram illustrating an example of a functional configuration of an electronic control unit (ECU) according to the embodiment;

FIG. 6 is a diagram for describing a diffusion resistance map; and

FIG. 7 is a flowchart showing an example of processing procedures for the lower limit voltage protection control according to the embodiment.

### DETAILED DESCRIPTION OF EMBODIMENTS

An embodiment of the present disclosure will be described in detail below with reference to the drawings. Note that the same or equivalent portions are denoted by the same signs throughout the drawings, and description of such portions will not be repeated.

In the following embodiment, a configuration in which an “all-solid-state battery system” according to the present disclosure is a vehicle will be described as an example. However, the “all-solid-state battery system” is not limited to a vehicle, and may be various types of stationary systems (home or business power storage system or the like).

### EMBODIMENT

### Vehicle Configuration

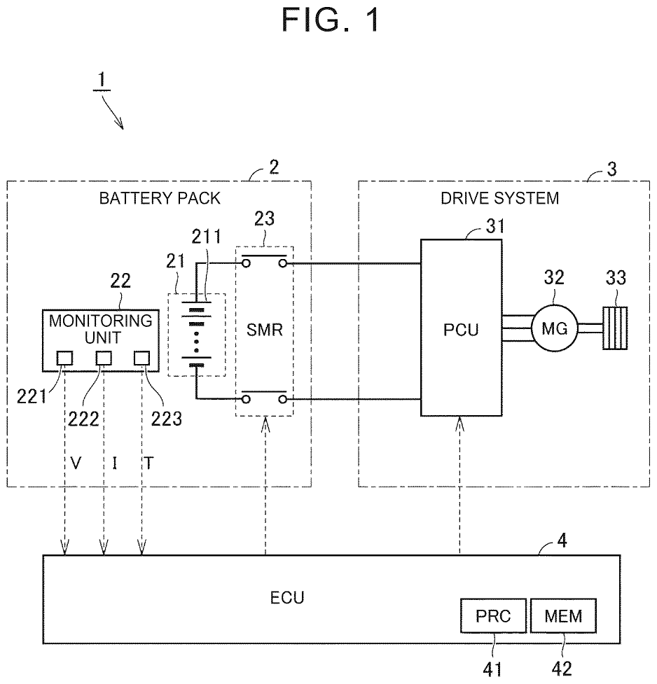

FIG. 1 is a block diagram illustrating an example of a hardware configuration of a vehicle according to the present embodiment. In this example, the vehicle 1 is a battery electric vehicle, but may be a hybrid electric vehicle or may be a plug-in hybrid electric vehicle. The vehicle 1 includes a battery pack 2, a drive system 3, and an electronic control unit (ECU) 4.

The battery pack 2 includes a battery 21, a monitoring unit 22, and a system main relay (SMR) 23.

The battery 21 is an all-solid-state lithium-ion battery. The battery 21 is a battery pack including a plurality of cells 211. Each of the cells 211 includes a cathode, an anode, and a solid electrolyte layer, as power storage elements.

The cathode includes a cathode active material layer and a cathode current collector. The cathode active material layer contains a cathode active material. The cathode active material is, for example, Li₂S. Examples of the cathode active material may include layered rock-salt active materials such as LiCoO₂, LiMnO₂, LiNiO₂, LiVO₂, LiNi_{1/3}Co=Mn_{1/3}O, and so forth, spinel active materials such as LiMn₂O—, Li₄TisO₁₂, Li(Ni_{0.5}Mn_{1.5})O₄, and so forth, and olivine active materials such as LiFePO₄, LiMnPO₄, LiNiPO₄, LiCoPO₄, and so forth.

The anode includes an anode active material layer and an anode current collector. The anode active material layer contains an anode active material. In the present embodiment, the anode active material is lithium titanate (Li₄TisO₁₂). However, the anode active material may contain at least one that is selected from a group consisting of, for example, graphite, Si, and SiOₓ (0<x<2).

The monitoring unit 22 includes a voltage sensor 221, a current sensor 222, and a temperature sensor 223. The voltage sensor 221 detects voltage V of the battery 21 (may be each cell). The current sensor 222 detects current I flowing through the battery 21. The temperature sensor 223 detects temperature T of the battery 21. Each of the sensors outputs detection results thereof to the ECU 4.

The drive system 3 includes a power control unit (PCU) 31, a traction motor generator 32, and drive wheels 33. The PCU 31 corresponds to “power conversion device” according to the present disclosure.

The ECU 4 includes a processor 41 such as a central processing unit (CPU), and memory 42 such as read-only memory (ROM) and random access memory (RAM). The processor 41 manages the battery 21 based on signals received from each sensor and programs stored in the memory 42. Also, the processor 41 controls the charging and discharging of the battery 21 by controlling the PCU 31 based on signals received from each sensor and on programs and maps stored in the memory 42. In the present embodiment, an example of primary control that is executed by the ECU 4 is “lower limit voltage protection control”, which will be described below.

### Lower Limit Voltage Protection Control

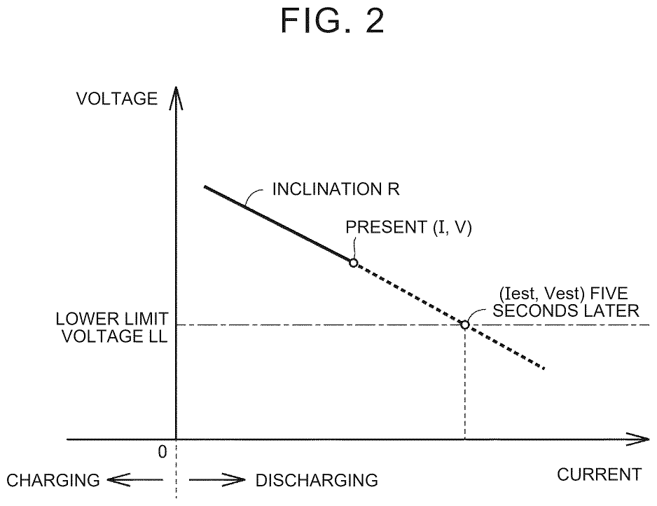

FIG. 2 is a diagram showing a relation between voltage and current of the battery 21. The horizontal axis represents the current flowing through the battery 21. The vertical axis represents the voltage of the battery 21. The rate of change (inclination) in a voltage-current graph such as shown in FIG. 2 corresponds to internal resistance R of the battery 21. The internal resistance R is calculated using a map (internal resistance map MP1, which will be described later) that is prepared in advance, in which the internal resistance R is a function of the temperature T and a State Of Charge (SOC).

The ECU 4 periodically calculates the internal resistance R of the battery 21 by referencing the map. The ECU 4 then estimates the voltage of the battery 21 at a specified amount of time after the present (five seconds in the following example) based on the combination (V, I) of the voltage V and current I of the battery 21 at the present (detected values of sensors), and the internal resistance R. For example, by estimating the current for five seconds later, assuming that the current I will change at the present rate, the voltage for five seconds later can be estimated from the present voltage V and the internal resistance R. The estimated voltage for five seconds later will be referred to hereinafter as “estimated voltage Vest”.

The ECU 4 controls the PCU 31 such that the estimated voltage Vest does not fall below a lower limit voltage LL. The lower limit voltage LL is a lower limit of an operating voltage range that is set in accordance with characteristics and specifications of the battery 21, such that the battery 21 can be protected. As a specific example, the lower limit voltage LL is a voltage equivalent to a lower limit voltage=1.5 V for each of the cells 211.

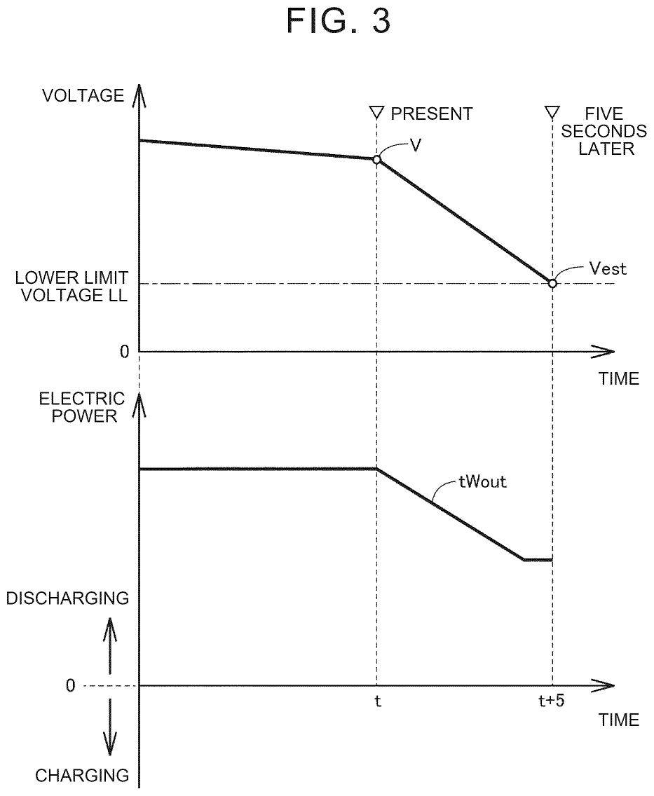

FIG. 3 is a diagram for schematically describing lower limit voltage protection control. The horizontal axis represents elapsed time. The upper vertical axis represents the voltage of the battery 21. The lower vertical axis represents discharged electric power from the battery 21.

When the estimated voltage Vest for five seconds later reaches the lower limit voltage LL, the ECU 4 suppresses the discharged electric power from the battery 21 so that the estimated voltage Vest does not decrease any further. The following Expression (1) is used for this suppression (output limitation), for example. The estimated voltage Vest in Expression (1) is equal to the lower limit voltage LL.

$$( Math 1 )$$

$$tWout = ( I + \frac{V - {V}_{est}}{R} ) \times {V}_{est} \qquad ( 1 )$$

Now, the present inventors took note that in the battery 21, which is an all-solid-state lithium-ion battery, error can occur between the value of the internal resistance R calculated from a map, and a precisely measured value. This means that there are cases in which the internal resistance R cannot be calculated with sufficient precision from the temperature T and the SOC alone. When there is error occurring in the internal resistance R, error will occur in discharged electric power tWout, and as a result, there is a possibility that the battery 21 cannot be appropriately protected even though the lower limit voltage protection control is executed.

Accordingly, in the present embodiment, the ECU 4 calculates diffusion resistance Rdyn of the battery 21, and corrects the internal resistance R based on the diffusion resistance Rdyn. This improves calculation precision of the discharged electric power tWout (reduces error in discharged electric power tWout). Thus, the battery 21 can be appropriately protected by the lower limit voltage protection control.

### Diffusion Resistance

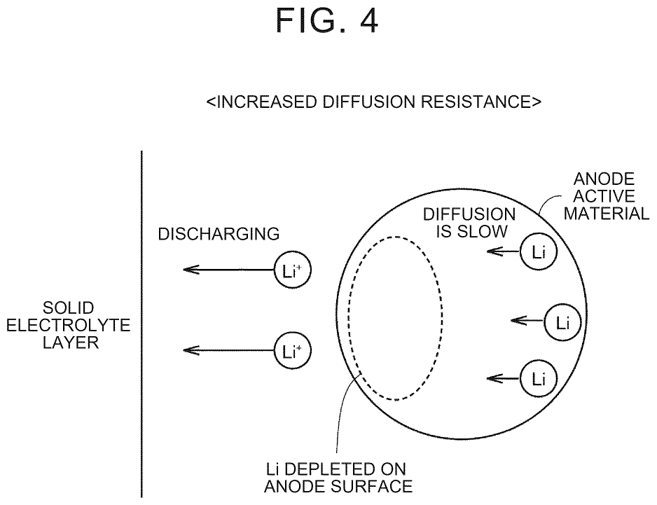

FIG. 4 is a conceptual diagram for describing diffusion resistance of the battery 21. In all-solid-state lithium-ion batteries, electrode reactions are less uniform than in liquid lithium-ion batteries, making it easier for lithium to react unevenly. To describe this in more detail, in the anode, lithium ion desorption reactions occurs preferentially in a region that is close to the solid electrolyte layer, which does not have fluidity, as compared with a region that is far from the solid electrolyte layer, resulting in uneven reaction. All-solid-state lithium-ion batteries do not contain an electrolyte with fluidity, and accordingly the diffusion of lithium ions in the anode (diffusion in solid phase) is slow. Accordingly, the uneven reaction occurring within the anode is not readily mitigated, and depletion of lithium can occur at the surface of the anode. Depletion of lithium at the surface of the anode can cause increase in internal resistance (diffusion resistance). This can be particularly pronounced when the battery 21 contains lithium titanate as the anode active material. Accordingly, it is preferable to calculate the internal resistance R taking into account the diffusion resistance Rdyn of the battery 21.

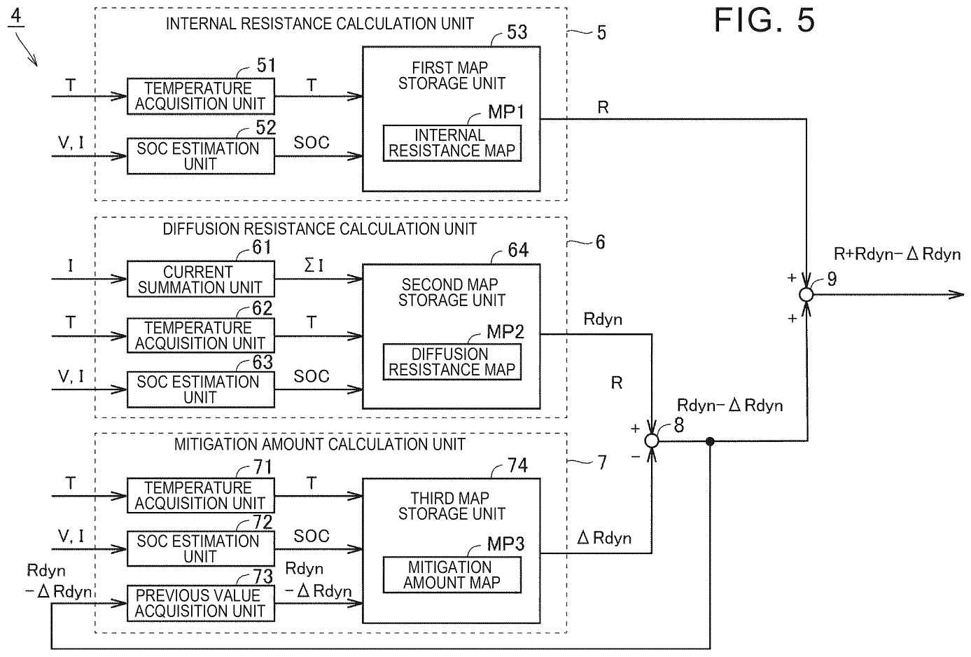

FIG. 5 is a functional block diagram illustrating an example of a functional configuration of the ECU 4 in the present embodiment. With reference to FIGS. 1 and 5, the ECU 4 includes an internal resistance calculation unit 5, a diffusion resistance calculation unit 6, a mitigation amount calculation unit 7, a subtraction unit 8, and an addition unit 9. Note that the functions of each of the blocks are realized by the processor 41 and/or the memory 42.

The internal resistance calculation unit 5 calculates the internal resistance R of the battery 21 (primarily contact resistance and resistance overvoltage). The internal resistance calculation unit 5 includes a temperature acquisition unit 51, an SOC estimation unit 52, and a first map storage unit 53.

The temperature acquisition unit 51 acquires the temperature T from the temperature sensor 223, and outputs the temperature T that is acquired to the first map storage unit 53.

The SOC estimation unit 52 acquires at least one of the voltage V from the voltage sensor 221 and the current I from the current sensor 222. The SOC estimation unit 52 estimates the SOC of the battery 21 by using a known method, such as referencing an SOC-open-circuit voltage (OCV) curve or performing summation of the current I. The SOC estimation unit 52 outputs the SOC that is estimated to the first map storage unit 53.

The first map storage unit 53 stores the internal resistance map MP1, in which the internal resistance R is defined for each combination (T, SOC) of the temperature T and the SOC. The first map storage unit 53 calculates the internal resistance R from (T, SOC) by referencing the internal resistance map MP1. The first map storage unit 53 outputs the internal resistance R that is calculated to the addition unit 9. The internal resistance map MP1 corresponds to “first information” according to the present disclosure.

The diffusion resistance calculation unit 6 calculates the diffusion resistance Rdyn of the battery 21. The diffusion resistance calculation unit 6 includes a current summation unit 61, a temperature acquisition unit 62, an SOC estimation unit 63, and a second map storage unit 64.

The current summation unit 61 performs summation of the current I (discharge current) that is acquired from the current sensor 222 to calculate a discharge current summation value EI. The current summation unit 61 may increase the discharge current summation value EI when the battery 21 is being discharged, and on the other hand may reduce the discharge current summation value EI when the battery 21 is being charged. The current summation unit 61 outputs the discharge current summation value EI, which is calculated, to the second map storage unit 64.

The temperature acquisition unit 62 acquires the temperature T from the temperature sensor 223, in the same way as the temperature acquisition unit 51. The temperature acquisition unit 62 outputs the temperature T, which is acquired, to the second map storage unit 64.

The SOC estimation unit 63 estimates the SOC of the battery 21, in the same way as the SOC estimation unit 52. The SOC estimation unit 63 outputs the SOC, which is estimated, to the second map storage unit 64.

The second map storage unit 64 stores a diffusion resistance map MP2, in which the diffusion resistance Rdyn is defined for each combination (EI, T, SOC) of the discharge current summation value EI, the temperature T, and the SOC.

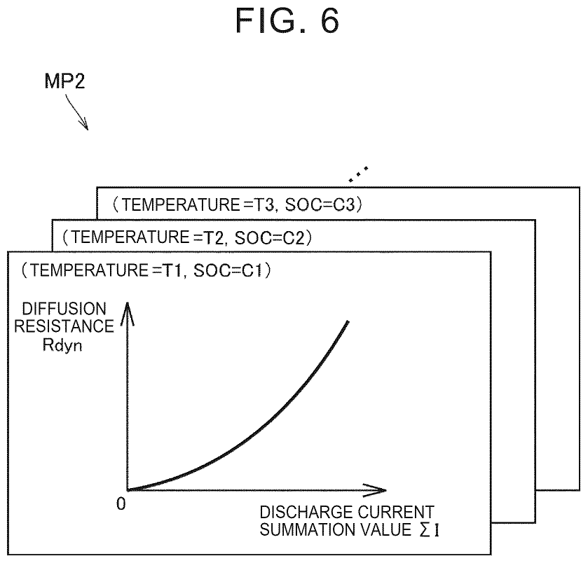

FIG. 6 is a diagram for describing the diffusion resistance map MP2. As shown in FIG. 6, the diffusion resistance map MP2 is a map in which, for example, a correlative relation between the discharge current summation value EI (horizontal axis) and the diffusion resistance Rdyn (vertical axis) is defined for each combination (T, SOC) of the temperature T and the SOC. Under the same conditions of the temperature T and SOC of the battery, the greater the discharge current summation value EI is, the greater the diffusion resistance Rdyn is. The diffusion resistance map MP2 corresponds to “second information” according to the present disclosure.

Returning to FIG. 5, the second map storage unit 64 calculates the diffusion resistance Rdyn from (EI, T, SOC), by referencing the diffusion resistance map MP2. The second map storage unit 64 outputs the diffusion resistance Rdyn that is calculated to the subtraction unit 8.

The mitigation amount calculation unit 7 calculates a mitigation amount ΔRdyn of the diffusion resistance Rdyn of the battery 21. Hereinafter, current values of the diffusion resistance Rdyn and the mitigation amount ΔRdyn are distinguished from previous values thereof by appending (n) to the current values and (n−1) to the previous values (n is a natural number). The mitigation amount calculation unit 7 includes a temperature acquisition unit 71, an SOC estimation unit 72, a previous value acquisition unit 73, and a third map storage unit 74.

The temperature acquisition unit 71 acquires the temperature T from the temperature sensor 223, in the same way as with the temperature acquisition units 51 and 62. The temperature acquisition unit 71 outputs the temperature T, which is acquired, to the third map storage unit 74.

The SOC estimation unit 72 estimates the SOC of the battery 21, in the same way as with the SOC estimation units 52 and 63. The SOC estimation unit 72 outputs the SOC, which is estimated, to the third map storage unit 74.

The previous value acquisition unit 73 acquires, from the subtraction unit 8, a value obtained by subtracting the previous mitigation amount ΔRdyn(n−1) from the previous diffusion resistance Rdyn(n−1) (i.e., previous corrected diffusion resistance Rdyn(n−1)). The previous value acquisition unit 73 outputs the acquired value (Rdyn(n−1)−ΔRdyn(n−1)) to the third map storage unit 74, for calculation of the current value ΔRdyn(n) of the mitigation amount.

The third map storage unit 74 stores a mitigation amount map MP3 in which the mitigation amount ΔRdyn is defined for each combination (T, SOC, Rdyn) of the temperature T, the SOC, and the diffusion resistance Rdyn. The mitigation amount map MP3 is created taking into consideration the mitigation of the unevenness of the lithium reaction over time (reduction in diffusion resistance). The third map storage unit 74 calculates the current value of the mitigation amount ΔRdyn(n) from (T, SOC, Rdyn) by referencing the mitigation amount map MP3. The third map storage unit 74 outputs the current value of the mitigation amount ΔRdyn(n) to the subtraction unit 8. The mitigation amount map MP3 corresponds to “third information” according to the present disclosure.

The subtraction unit 8 corrects the diffusion resistance Rdyn by subtracting the current value of the mitigation amount ΔRdyn(n) from the current value of the diffusion resistance Rdyn(n). The subtraction unit 8 outputs the subtraction results (Rdyn(n)−ΔRdyn(n)) to the addition unit 9. The subtraction unit 8 also outputs the subtraction results to the previous value acquisition unit 73 in preparation for the next calculation.

The addition unit 9 corrects the internal resistance R by adding the subtraction results (Rdyn(n)−ΔRdyn(n)), which are obtained by the subtraction unit 8, to the internal resistance R. The addition unit 9 outputs the addition results (R+Rdyn(n)−ΔRdyn(n)) to a control unit (omitted from illustration) of the PCU 31. Thus, the internal resistance R that is corrected by the diffusion resistance Rdyn is reflected in the discharged electric power tWout, and output limitation of the discharged electric power tWout of the battery 21 is realized.

### Flow of Processing

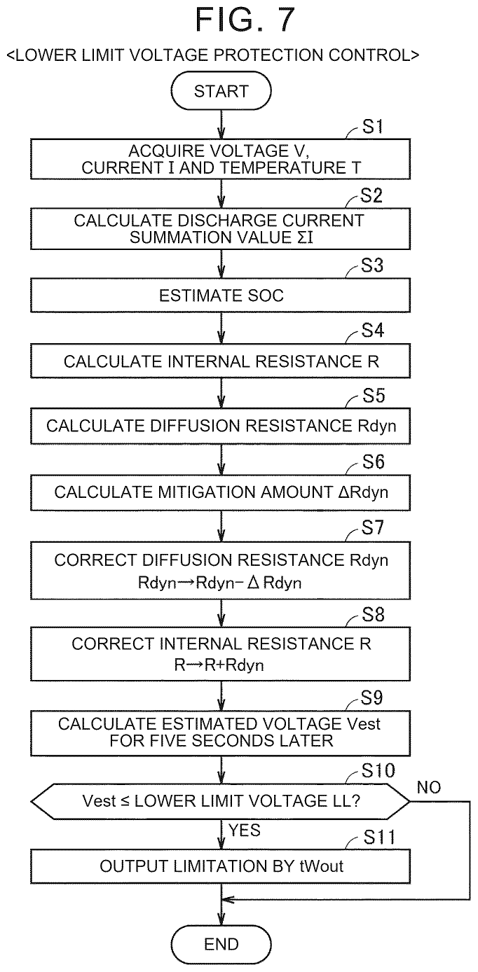

FIG. 7 is a flowchart showing an example of processing procedures for the lower limit voltage protection control according to the present embodiment. The processing that is shown in this flowchart is executed when a condition, set in advance, is satisfied (e.g., at cycles set in advance). Each step is realized by software processing by the ECU 4, but may also be realized by hardware (electrical circuitry) that is disposed within the ECU 4. Hereinafter, the term “step” will be abbreviated to “S.”

Referencing FIGS. 1, 5 and 7, in S1, the ECU 4 acquires the present voltage V from the voltage sensor 221, acquires the present current I from the current sensor 222, and acquires the temperature T from the temperature sensor 223.

In S2, the ECU 4 performs summation of the current I to calculate the discharge current summation value ΣI.

In S3, the ECU 4 estimates the SOC from the voltage V by referencing the SOC-OCV curve that is omitted from illustration. The ECU 4 may estimate the SOC from the discharge current summation value EI.

In S4, the ECU 4 calculates the internal resistance R from the temperature T and the SOC. The internal resistance R is calculated using the internal resistance map MP1.

In S5, the ECU 4 calculates the diffusion resistance Rdyn from the discharge current summation value ΣI, the temperature T, and the SOC. The diffusion resistance Rdyn is calculated using the diffusion resistance map MP2 (see FIG. 6). Note that the ECU 4 may calculate the diffusion resistance Rdyn from just the discharge current summation value ΣI. That is to say, the ECU 4 may calculate the diffusion resistance Rdyn without using the temperature T and the SOC. However, using the temperature T and the SOC enables precision of calculation of the diffusion resistance Rdyn to be improved.

In S6, the ECU 4 calculates the current value of the mitigation amount ΔRdyn(n) from the temperature T, the SOC, and the previous value Rdyn(n−1) of the diffusion resistance. The current value of the mitigation amount ΔRdyn(n) is calculated using the mitigation amount map MP3.

In S7, the ECU 4 corrects the diffusion resistance Rdyn that is calculated in S5 by using the current value of the mitigation amount ΔRdyn(n) that is calculated in S6. That is to say, the ECU 4 calculates a value obtained by subtracting the current value of the mitigation amount ΔRdyn(n) from the current value of the diffusion resistance Rdyn(n) as the diffusion resistance Rdyn that is corrected.

In S8, the ECU 4 corrects the internal resistance R that is calculated in S4 using the corrected diffusion resistance Rdyn that is calculated in S7. That is to say, the ECU 4 calculates a value obtained by adding the diffusion resistance Rdyn, which is corrected, to the internal resistance R, as the internal resistance R that is corrected.

In S9, the ECU 4 calculates an estimated voltage Vest for five seconds later. For example, the ECU 4 calculates an estimated current Iest for five seconds later under the assumption that the present rate of change of the current I will be maintained. Thus, the amount of voltage change ΔV in conjunction with the change in current from I to Iest is expressed as ΔV=(I−Iest)/R. The ECU 4 can calculate the estimated current Iest for five seconds later from Vest=V+ΔV.

In S10, the ECU 4 determines whether the estimated voltage Vest for five seconds later is the lower limit voltage LL or lower. The lower limit voltage LL is determined in advance in accordance with the characteristics (material), specifications (application), and so forth, of the battery 21. When the estimated voltage Vest for five seconds later is the lower limit voltage LL or lower (YES in S10), the ECU 4 advances the processing to S11. On the other hand, when the estimated voltage Vest for five seconds later is higher than the lower limit voltage LL (NO in S10), the ECU 4 skips the processing of S11 and ends the series of processing.

In S11, the ECU 4 calculates the discharged electric power tWout by substituting the voltage V and the current I that are acquired in S1, and the corrected internal resistance R that is calculated in S8, into the above Expression (1). The ECU 4 then controls the PCU 31 such that the discharged electric power of the battery 21 becomes tWout.

As described above, in the present embodiment, the ECU 4 calculates the diffusion resistance Rdyn by using the discharge current summation value ΣI of the battery 21, and corrects the internal resistance R by the diffusion resistance Rdyn that is calculated. Thus, the increase in resistance caused by the slow diffusion of lithium ions in the anode (resulting in uneven reaction) is reflected in the internal resistance R, thereby improving the precision of calculation of the internal resistance R. As a result, output limitation based on the discharged electric power tWout in the lower limit voltage protection control can be appropriately executed. Therefore, according to the present embodiment, the battery 21, which is an all-solid-state lithium-ion battery, can be appropriately protected.

As described with reference to FIG. 5, in calculating the discharge current summation value ΣI of the battery 21, the ECU 4 may increase the discharge current summation value ΣI when the battery 21 is discharging, and on the other hand may reduce the discharge current summation value ΣI when the battery 21 is charging. Reducing the discharge current summation value ΣI, when the battery 21 is being charged, reflects the active mitigation amount of reaction unevenness due to charging in the diffusion resistance Rdyn. Accordingly, precision of calculating the diffusion resistance Rdyn is improved, and hence, the precision of calculating the internal resistance R is further improved. Note, however, that the discharge current summation value ΣI does not have to be reduced during charging.

Description has been made with reference to FIGS. 5 and 7 that the diffusion resistance Rdyn is corrected by the mitigation amount ΔRdyn. Performing correction using the mitigation amount ΔRdyn reflects the mitigation amount of the reaction unevenness over time in the diffusion resistance Rdyn. Accordingly, precision of calculating the diffusion resistance Rdyn is improved, and hence, the precision of calculating the internal resistance R is further improved. Note, however, that correction using the mitigation amount ΔRdyn does not have to be performed.

For the temperature T and SOC when using the internal resistance map MP1, the diffusion resistance map MP2, and the mitigation amount map MP3, the minimum temperature Tmin and the minimum SOCmin are preferably used from among the temperatures T and SOCs of the multiple cells 211 included in the battery 21. In general, the lower the temperature is, and also the lower the SOC is, the higher the resistance (internal resistance and diffusion resistance) will be. Accordingly, using the minimum temperature Tmin and the minimum SOCmin enables the maximum value of the internal resistance R and the diffusion resistance Rdyn to be calculated. In this case, the R in the denominator of the above Expression (1) becomes maximal, and therefore the discharged electric power tWout becomes minimal. That is to say, the output limitation of the battery 21 becomes the strictest. This enables the battery 21 to be protected even more appropriately.

The embodiment disclosed herein should be considered to be exemplary in all respects and not restrictive. The scope of the present disclosure is set forth in the claims rather than in the above description of the embodiment, and is intended to include all modifications within the meaning and scope equivalent to the claims.

What is claimed is:

1. An all-solid-state battery system, comprising:
a battery that is an all-solid-state lithium-ion battery;
a voltage sensor for detecting a voltage of the battery;
a current sensor for detecting a current of the battery;
a temperature sensor for detecting a temperature of the battery;
a power conversion device that is configured to charge and discharge the battery; and
a control device for controlling the power conversion device, wherein
the control device
calculates an internal resistance of the battery based on first information including the temperature and a state of charge (SOC) of the battery,
calculates a diffusion resistance of the battery based on second information including a discharge current summation value of the battery,
corrects the internal resistance by adding the diffusion resistance to the internal resistance,
estimates the voltage of the battery at a specified amount of time after present, based on the internal resistance that is corrected, a present voltage of the battery, and a present current of the battery, and
controls the power conversion device such that the voltage that is estimated does not fall below a lower limit voltage.

2. The all-solid-state battery system according to claim 1, wherein
the second information further includes the temperature and the SOC of the battery, and
the control device
increases the discharge current summation value when the battery is being discharged, and also reduces the discharge current summation value when the battery is being charged, and
calculates the diffusion resistance such that the greater the discharge current summation value is, the more the diffusion resistance increases, under conditions in which the temperature and the SOC of the battery are the same.

3. The all-solid-state battery system according to claim 2, wherein
the control device is configured to repeatedly calculate the diffusion resistance, and
the control device
calculates the internal resistance based on the first information,
calculates a current value of the diffusion resistance based on the second information,
calculates a mitigation amount of the diffusion resistance based on third information including the temperature and the SOC of the battery, and a previous value of the diffusion resistance,
corrects the current value of the diffusion resistance by subtracting the mitigation amount from the current value of the diffusion resistance, and
corrects the internal resistance by adding the current value that is corrected to the internal resistance.

4. The all-solid-state battery system according to claim 3, wherein
the battery is a battery pack including a plurality of cells, and
the control device uses a lowest temperature and a lowest SOC among temperatures and SOCs of the cells as the first information through the third information.

5. The all-solid-state battery system according to claim 1, wherein the battery includes lithium titanate as an anode active material.
